(19) United States
(12) Patent Application Publication
(10) Pub. No.: US 2008/0091777 A1
(43) Pub. Date: Apr. 17, 2008

(54) Method, system and program product for building collaboration applications using multiple-peer user interface libraries

(75) Inventor: Cohan S. Carlos, Raleigh, NC (US)

Correspondence Address: SILVY ANNA MURPHY, 100 TURNBERRY LANE, CARY, NC, 27518, US

(73) Assignee: International Business Machines Corporation, Armonk, NY (US)

(21) Appl. No.: 11/546,691

(22) Filed: Oct. 12, 2006

(51) Int. Cl. G06F 15/16

(52) U.S. Cl. 709/204

(57) ABSTRACT

A method, system and program product for building a collaboration server for deploying a collaboration application. The method includes installing on a server a collaboration server application having multiple-peer user interface libraries capable of creating and synchronizing multiple peer widgets for each widget created by a collaboration application. The method further includes deploying a collaboration application written using standard user interface libraries, and launching execution of the collaboration application on the server when one or more users connect to the server, such that a rendering of a shared state of the user interface is displayed on a client program corresponding to the users. Further, the method includes displaying the shared state on a client program of a new user connecting to the server. Also, when a change is made to the state of a shared widget by a user, the method includes updating the client programs of all remaining users.

### FIELD OF THE INVENTION

The present invention relates to a method and system for building collaboration applications and a computer program product for deploying the collaboration applications in a deployment environment, often referred to as a collaboration server. More particularly, the present invention relates to a method, system and computer program product for building a collaboration server for facilitating deployment of collaboration applications on the collaboration server using multiple-peer user interface libraries.

### BACKGROUND OF THE INVENTION

In today's business environment, organizations and/or businesses facilitate collaboration among employees and/or end users. Collaboration in various settings is achieved by using collaboration technologies. With the use of collaboration technologies, employees of a business and/or organization scattered throughout the world can collaborate with one another on a project or end users accessing various collaboration software can chat with one another or play a game with one another. Traditional collaboration technologies for developing collaboration applications require programmers to write collaboration applications in multiple languages, with some pieces deployed on client programs and some pieces on collaboration servers. Further, traditional technologies require a programmer to be aware of the existence of a network and to use an application-specific communication protocol for communicating with the different components, thus, making the collaboration applications written in traditional ways difficult to test and to initialize with a complex state. As such, there is a need for an efficient and cost effective way to develop collaboration technologies that promote collaboration and which overcome the limitations of traditional collaboration technologies.

### SUMMARY OF THE INVENTION

In a first aspect of the invention, there is provided a method of building a collaboration server for facilitating deployment of a collaboration application. The method includes installing a collaboration server application on a server connected to a network and being configured to run a collaboration application using one or more customized user interface libraries having collaboration functionality, each of the one or more customized user interface libraries having one or more customized widgets capable of mapping to one or more peer widgets, deploying a collaboration application on the server, wherein a user interface of the collaboration application is written using one or more standard user interface libraries, and launching execution of the collaboration application on the server when one or more collaborating users of a collaborating group connect to the server over the network, such that a rendering of a shared state of the user interface is displayed on a client program corresponding to each of the one or more collaborating users connected to the server. When a new collaborating user connects to the server for collaborating with the one or more collaborating users, the method further includes displaying the shared state of the user interface on another client program corresponding to the new collaborating user. Further, when a change is made to the shared state of the user interface by a collaborating user among the one or more collaborating users, the method includes broadcasting the change made to the shared state to a remainder of the one or more collaborating users. In an embodiment, the displaying step includes keying the shared state of the user interface to the collaboration group, storing the shared state of the user interface on the server, and displaying the rendering of the shared state of the user interface on the another client program corresponding to the new collaborating user when the new collaborating user connects to the server. In an embodiment, the broadcasting step includes issuing a notification to each client program corresponding to the remainder of the one or more collaborating users, such that the rendering of the shared state of the user interface is updated to reflect the change made to the shared state of the user interface. In an embodiment, the new collaborating user is either a first user in the collaborating group who connects to the server at an initial point-in-time or is a subsequent user in the collaborating group who connects to the server at a subsequent point-in-time. Further, in an embodiment, the change made to the shared state of the user interface is broadcasted across the network using a protocol chosen from an Internet protocol suite. Moreover, in an embodiment, the collaboration application and the collaboration server application are applications written in an object-oriented programming language.

In another aspect of the invention, there is provided a system for facilitating collaboration in an online collaborative environment. The system includes a collaboration server application installed on a server coupled to a network and being configured to run a collaboration application using one or more modified widget libraries includes of one or more customized widgets, each customized widget of the one or more customized widgets being configured to map to one or more peer widgets created on one or more local user interfaces corresponding to one or more collaborating users connected to the server, and a collaboration application deployed on the server, the collaboration server application being configured to run the collaboration application on the server when a collaborating user connects to the server, such that a shared part of a user interface of the collaboration application run on the server is stored on the server in order to display the shared part of the user interface on each local user interface corresponding to each of the collaborating users connected to the server and wherein any change made to the shared part of the user interface displayed on a local user interface of a collaborating user among the collaborating users is broadcasted and displayed on each remaining local user interface corresponding to each remaining collaborating user among the collaborating users connected to the server. In an embodiment, the collaboration server application is configured to key the shared part of the user interface to a collaboration group that includes the collaborating users. Further, the collaboration server application is configured to display the shared part of the user interface on a local user interface of a new collaborating user when the new collaborating user connects to the server. In an embodiment, the new collaborating user is either a first user in the collaborating group who connects to the server at an initial point-in-time or a subsequent user in the collaborating group who connects to the server at a subsequent point-in-time. In an embodiment, the collaboration server application is further configured to issue a notification to each local user interface corresponding to the each remaining collaborating users of the collaborating users connected to the server in order to update and display any change made to the shared part of the user interface. Further, in an embodiment, the change made to the shared state of the user interface is broadcasted across the network using a protocol chosen from an Internet protocol suite. Moreover, in an embodiment, the collaboration application and the collaboration server application are applications written in an object-oriented programming language.

In yet another embodiment, the present invention provides a computer program product for building a collaboration server application that facilitates deployment of a collaboration application. The computer program product includes a computer readable medium, first program instructions to install a collaboration server application on a host server connected to a network, the collaboration server application being configured to run a collaboration application using customized widget libraries that include one or more customized widgets, each of the customized widgets being capable of creating one or more peer widgets on each local user interface of a client program corresponding to each of one or more collaborating users connected to the host server. Further, the computer program product includes second program instructions to run on the host server a collaboration application deployed thereon, the collaboration application having a user interface written using one or more standard widget libraries and third program instructions to display a shared part of the user interface of the collaboration application on a local user interface of a client program corresponding to a new collaborating user when the new collaborating user connects to the host server. In an embodiment, the new collaborating user includes at least one of: a first user in the collaborating group who connects to the host server at an initial point-in-time or a subsequent user in the collaborating group who connects to the host server at a subsequent point-in-time. In an embodiment, the second program instructions include instructions to key to a collaborating group the shared part of the user interface displayed as each local user interface corresponding to the one or more collaborating users. In an embodiment, the third program instructions include instructions to share between the one or more collaborating users one or more customized widgets used to render the shared part of the user interface displayed as the local user interface on the client program corresponding to the one or more collaborating users. Furthermore, the computer program product includes fourth program instructions to update the shared part of the user interface displayed on the each local user interface corresponding to the one or more collaborating users when a change is made to the shared part of the user interface by any of the one or more collaborating users. In an embodiment, the fourth program instructions include instructions to transmit over the network the change made to the shared part of the user interface displayed as the local user interface using a protocol chosen from an Internet protocol suite. In an embodiment, each of the first, second, third and fourth program instructions are stored on the computer readable medium. In an embodiment, both the collaboration application and the collaboration server application are applications written in an object-oriented programming language.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a flowchart which outlines the steps involved in processing different types of events that are received by a host server or system from a client program, in accordance with an embodiment of the present invention.

FIG. 2 depicts a flowchart which outlines the steps involved in processing UI (User Interface) widget events that are received by a host server or system from a client program, in accordance with an embodiment of the present invention.

FIG. 3 depicts a flowchart which outlines the steps involved in creating peer widgets on collaborating client programs when a shared widget is created by the collaboration application running on the host server or system, in accordance with an embodiment of the present invention.

FIG. 4 depicts a flowchart which outlines the steps involved in communicating to one or more collaborating client programs changes in state of a shared widget that is modified on the host server or system, in accordance with an embodiment of the present invention.

FIG. 5 depicts a collaboration system that includes a plurality of clients and a server connected over a network communications channel, with the server having a collaboration server application implemented thereon for facilitating deployment of a collaboration application on the server for providing collaboration among one or more clients, in accordance with an embodiment of the present invention.

FIG. 6 is a schematic block system diagram illustrating an embodiment of a server having a collaboration server application implemented thereon for facilitating deployment of a collaboration application on the server, in accordance with an embodiment of the present invention.

FIG. 7 is a schematic block system diagram illustrating an embodiment of a collaboration server application for facilitating deployment of a collaboration application for providing collaboration among one or more clients, in accordance with an embodiment of the present invention.

FIG. 8 is a schematic block system diagram illustrating an embodiment of a collaboration system having a collaboration server application or computer program product implemented thereon for facilitating deployment of a collaboration application on the server for collaboration among users, in accordance with an embodiment of the present invention.

### BEST MODE FOR CARRYING OUT THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network. Furthermore, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

In one embodiment, the invention provides a method of building a collaboration server for facilitating deployment of a collaboration application. The method includes installing a collaboration server application on a server connected to a network and being configured to run a collaboration application using one or more customized user interface libraries having collaboration functionality, each of the one or more customized user interface libraries being configured to create one or more customized widgets capable of mapping to one or more peer widgets, deploying a collaboration application on the server, wherein a user interface of the collaboration application is written using one or more standard user interface libraries, and launching execution of the collaboration application on the server when one or more collaborating users of a collaborating group connect to the server over the network, such that a rendering of a shared state of the user interface is displayed on a client program corresponding to each of the one or more collaborating users connected to the server. When a new collaborating user connects to the server for collaborating with the one or more collaborating users, the method further includes displaying the shared state of the user interface on another client program corresponding to the new collaborating user. Further, when a change is made to the shared state of the user interface by a collaborating user among the one or more collaborating users, the method includes broadcasting the change made to the shared state to a remainder of the one or more collaborating users. In an embodiment, the displaying step includes keying the shared state of the user interface to the collaboration group, storing the shared state of the user interface on the server, and displaying the rendering of the shared state of the user interface on the another client program corresponding to the new collaborating user upon launching of the collaboration application when the new collaborating user connects to the server. In an embodiment, the broadcasting step includes issuing a notification to each client program corresponding to the remainder of the one or more collaborating users, such that the rendering of the shared state of the user interface is updated to reflect the change made to the shared state of the user interface.

In an embodiment, the new collaborating user is either a first user in the collaborating group who connects to the server at an initial point-in-time or is a subsequent user in the collaborating group who connects to the server at a subsequent point-in-time. Further, in an embodiment, the change made to the shared state of the user interface is broadcasted across the network using a protocol chosen from an Internet protocol suite. In an embodiment, the change made to the shared state of the user interface is broadcasted across the network using a HTTP (Hypertext Transfer Protocol) Internet protocol. Moreover, in an embodiment, the collaboration application and the collaboration server application are applications written in an object-oriented programming language. In an embodiment, the collaboration application and the collaboration server application are applications written in the Java programming language. Although, the description herein below describes both the collaboration application or program and the collaboration server application as programs written in the Java programming language, it should be understood that the respective applications or programs can be written in any other object-oriented or object-based or interpreted or compiled programming language by one skilled in the art. Moreover, in an embodiment, the client program used by the one or more collaborating users is a web browser.

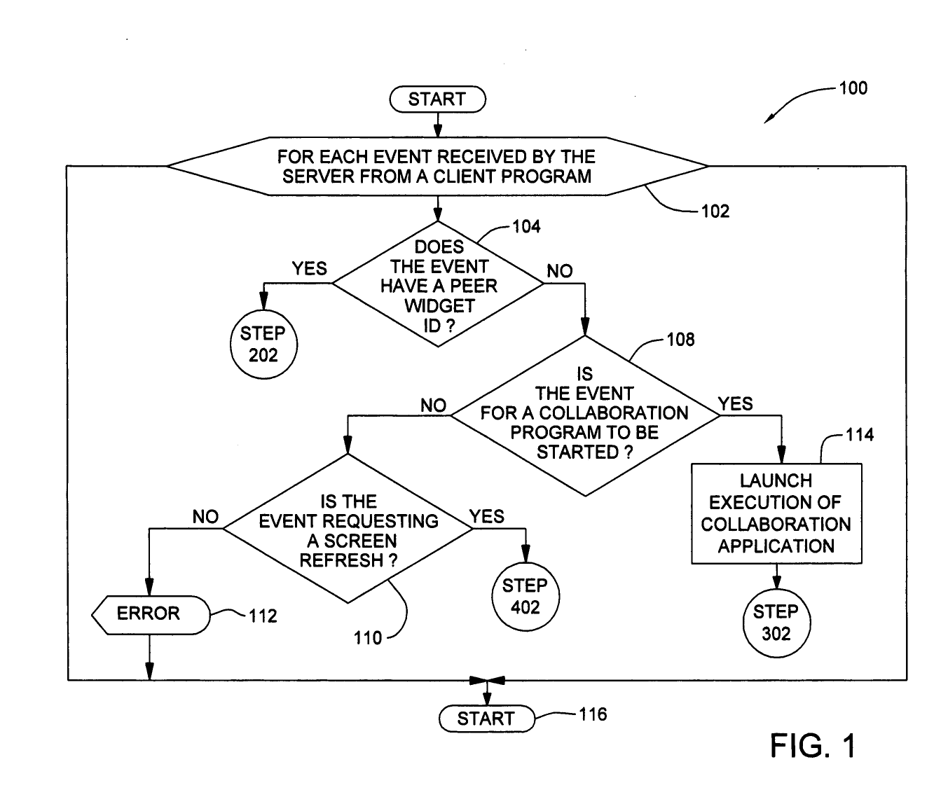

Reference is now made to FIGS. 1 through 4, which illustrate a method of building a collaboration server for facilitating deployment of a collaboration application written using standard UI (User Interface) libraries on the collaboration server. As used herein the term “host server” or “host system” refers to a server or system that has installed thereon a collaboration server application for facilitating deployment of a collaboration application or program written using standard UI libraries and which allows collaboration among users. Further, the term “collaboration server application” refers to an application installed on the host server for facilitating deployment of a collaboration application. Also, as used herein the term “collaboration server” refers to the deployment environment, namely, the host server having installed thereon the collaboration server application. In particular, the collaboration server application uses UI libraries that are implemented so that UI widgets can have multiple-peer widgets. Furthermore, the term “collaboration application” refers to an application or program written by a programmer to run using the collaboration server application, for example, a gaming application or program or a chat application or program that is used for collaborating with other users. Further, the collaboration application deployed using the collaboration server application may be written as a simple one-user or standalone single program rather than different programs, where the standalone program can be run on a laptop or computer using a virtual machine without the involvement of a network. Thus, the collaboration server application allows programmers to program using standard Java widget or user interface (UI) libraries as if they were writing standalone applications rather than online collaboration applications.

Typically, a standard Java UI library is made up of Java classes and Java interfaces, which implement or define Java methods. When a Java collaboration application or program runs, it creates widget trees. A widget tree is the tree representation of widgets, widget groups and frames in a screen. The largest widget, the frame, is the root of the tree. Each group that is contained within a larger widget is a branch of the widget tree. The widgets that do not contain other widgets, (buttons for example) are leaves of the widget tree. The Java widgets are used to create the user interface of the collaboration application. Each program typically uses one widget library, though multiple libraries may be used. If a programmer wants to add a Java widget to a parent widget tree in an application, the programmer uses Java program calls. The calls depend on the widget library. Each library has its own procedures for adding widgets to widget trees. The association between a java layer widget and a native layer widget is created when a newly created java widget is added to a widget tree or when the widget tree is made visible. The native layer is the underlying display context where the user interface is displayed. In a typical Java program, the native layer is the operating system, which includes the libraries that the operating system uses to draw frames and widgets on a computer screen. For a simple Java program running on a laptop, the native layer could be the Windows® operating system with its GDI (Graphic Device Interface) and SDK (software Development Kit) libraries or the Macintosh® operating system and its associated libraries or the Linux® operating system with its Motif, GTK (Gimp Tool Kit) or a Qt libraries. The programmer adds widgets to a widget tree to create a GUI (Graphical User Interface).

In a standard Java UI library, the Java widget objects correspond one to one with the native widgets that they encapsulate. A Java widget is never associated with more than one native or peer widget at any given time. A Java widget has a peer widget that it uses to render itself on the host operating system. The peer widget uses the Java widget to communicate with the Java user program, through its event handlers and through manipulation of the state of the Java widget. A typical Java widget cannot be added to two widget trees because each widget is only mapped to one peer. For a widget to appear in two places, it must be mapped to two peers. To build a collaboration server that can utilize the standard Java widget libraries that programmers have used to write a standalone Java program, the collaboration server application includes multiple-peer or customized UI libraries. The customized or multiple-peer widget libraries form part of the collaboration server application and, therefore, are placed on the host server. The customized or multiple-peer UI libraries with the collaboration functionality allow clients to connect to the collaboration server application using a web browser or any other client program and to use the collaboration application installed thereon. Client programs do not have to be built using a non-standard UI library since the multiple-peer UI libraries on the server have the same set of Java classes and Java methods as a standard UI library. When a multiple-peer UI library is requested by an instance of a collaboration application to create a widget, it creates a Java object (the widget) on the server and it creates a peer widget in the client program as well. When there are multiple collaborating users running multiple collaboration applications with shared widget trees, some widgets will need to manage multiple peer widgets, one for each collaborating user. So the UI libraries in the collaboration server application are capable of creating multiple peer widgets and synchronizing multiple peer widgets (making sure that shared widgets have the same state on each of the client programs at any given time). Each Java widget has a state, which can be changed by user actions and the collaboration application. When a widget has a change in shared, the widget redraws or renders the new state on each user's client program. The state of a shared widget refers to any attribute, for example, color and dimensions that a shared widget possesses and displays to multiple users. Another example of a shared state is the position of a shared widget, for instance, a chess piece on a shared chessboard. The collaboration application is launched when the first user belonging to a certain collaborating group connects to the server using the collaboration server application. When the collaboration application runs, if a Java object representing a frame is created in Java, then the user's client program is sent a representation of the frame to be displayed on the user's client program. The object that is displayed in the user's client program is called the peer object and a mapping of the peer object to the Java object is stored on the collaboration server. As such, every widget in Java has an equivalent peer widget on the user's client program. When a user enters a collaboration context, the collaboration application creates the shared parts of the user interface by reusing shared widgets and widget trees. A new user commences working with the shared widgets like all the other collaborating users. So collaboration is achieved by sharing Java widgets or widget trees between the collaborating users.

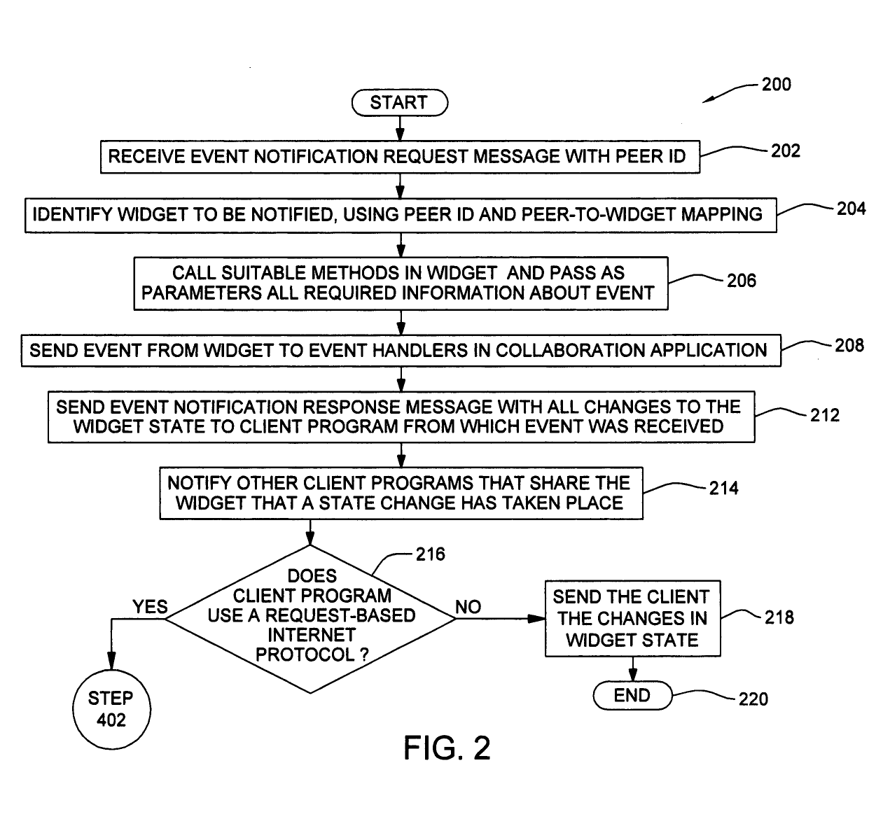

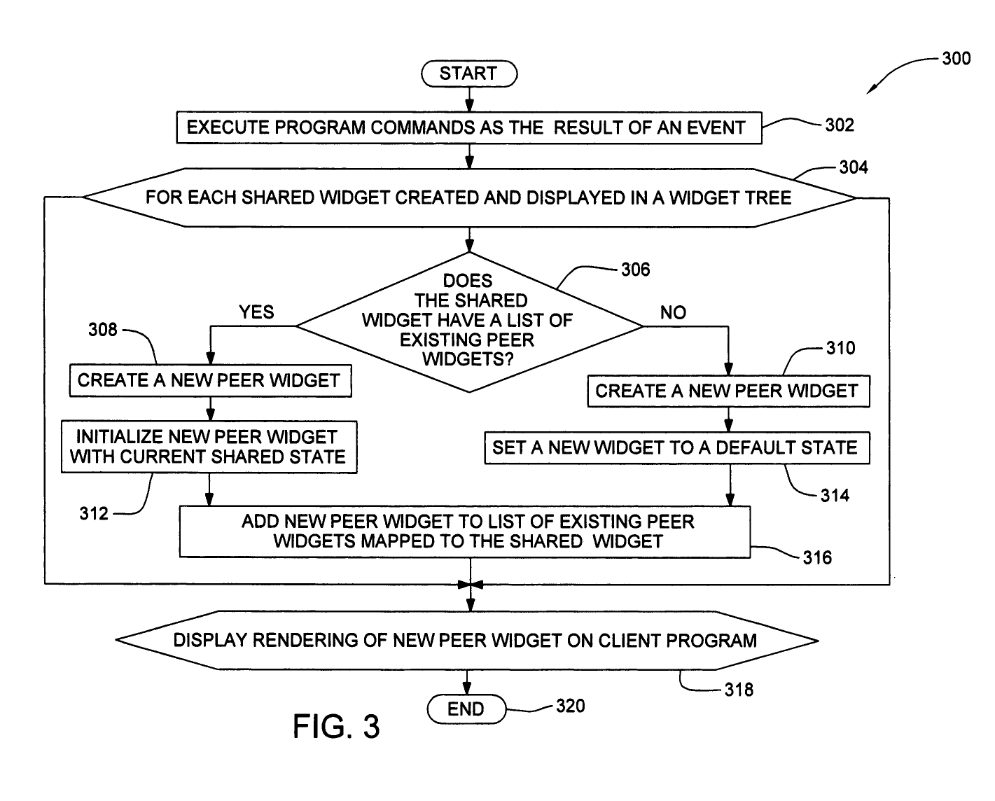

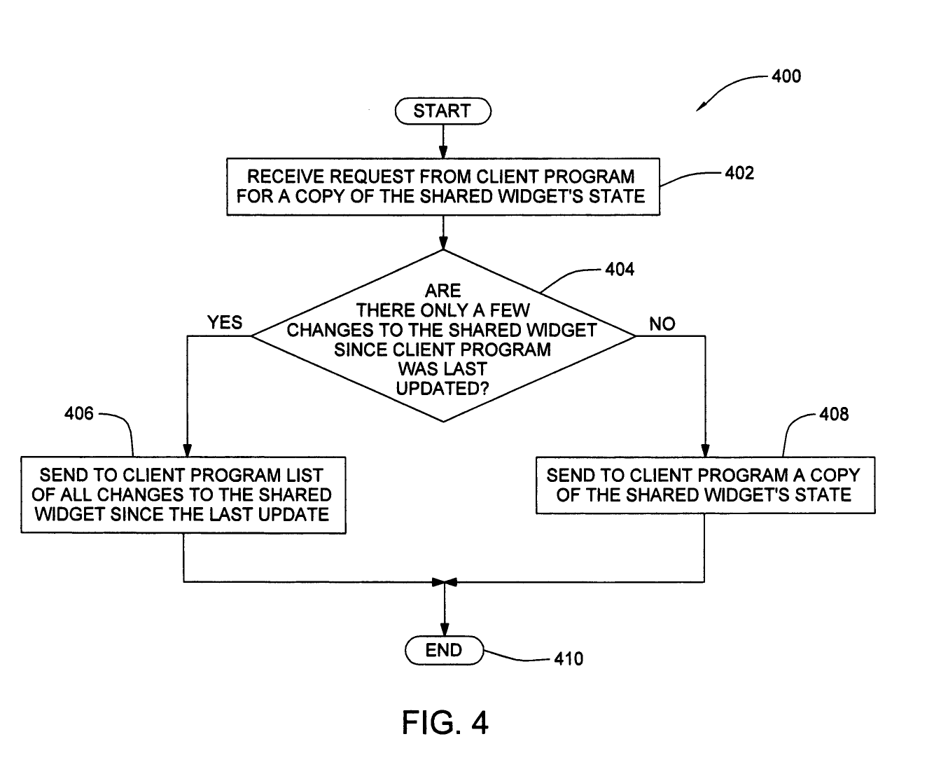

Turning to FIG. 1, numeral 100 depicts a flowchart which outlines the steps involved in processing different types of events that are received by a host server or system from a client program, for example, a browser program, and are to be displayed to others by a collaboration server, in accordance with an embodiment of the invention. The term “event” refers to an action or occurrence detected by a client program, such as the clicking of a button or the pressing of a key, etc., as well as the launching of a program, for instance, when a user first connects to a collaboration server application. As shown in FIG. 1, for each event notification received in step 102 from a client program by the collaboration server application (installed on a host server), the collaboration server application determines whether the event has a peer widget ID in step 104. If the event has a peer widget ID in step 104 (“Y” branch), then the process continues with step 202 in FIG. 2, whereby the collaboration server application processes the event, as will be discussed herein below with respect to FIG. 2. However, if the event does not have a peer widget ID in step 104 (“N” branch), then the collaboration server application determines in step 108 whether or not the event is for starting or launching a collaboration application or program. If the event is for starting a collaboration application or program in step 108 (“Y” branch), then the collaboration server application launches execution of the collaboration application or program and the process continues with step 302 in FIG. 3, whereby the collaboration server application creates peer widgets, as will be discussed herein below with respect to FIG. 3. On the other hand, in step 108, if the event is not for starting a collaboration program (“N” branch), then the collaboration server application determines in step 110 whether or not the event is for requesting a screen refresh, for instance, when a state of a shared widget has changed. If the event is not for requesting a screen refresh in step 110 (“N” branch), then an error message is generated in step 112, ending the process at step 116. However, if in step 110, the event is for requesting a screen refresh (“Y” branch), then the collaboration server application recreates all the peer widgets that need to be updated by continuing the process outlined in FIG. 4, starting with step 402, whereby any changes in state are set for the new peer widgets and the changes in state are communicated to one or more collaborating client programs, as discussed herein below with respect to FIG. 4.

Turning to FIG. 2, reference numeral 200 depicts a flowchart which outlines the steps involved in processing UI or peer widget events that are received by a collaboration server application (on a host server or system) from a client program in step 102 of FIG. 1. In particular, when it is determined in step 104 of FIG. 1 that the event has a peer widget ID, the collaboration server application receives in step 202 the event notification request message along with the peer widget ID. The collaboration server application identifies in step 204 the widget that is to be notified using the peer widget ID and the peer-to-widget mapping provided by the multiple-peer UI library. As such, the collaboration server application calls in step 206 suitable methods in the widget and passes as parameters all required information about the event. In step 208, the collaboration server application sends the event from the widget to event handlers in the collaboration application deployed on the collaboration server application. In step 212, the collaboration server application sends to the client program from which the event was received, a response message with all changes to the widgets' states resulting from the handling of the event. Further, in step 214, the collaboration server application notifies other client program(s) that share any modified widgets that a state change has taken place. The collaboration server application makes a determination in step 216 as to whether or not the other client program(s) use a request-based Internet protocol. If it is determined in step 216 that a client program uses a request-based Internet protocol (“Y” branch), then the process continues with step 402 in FIG. 4, as will be discussed herein below with respect to FIG. 4. However, if it is determined in step 216 that the client program does not use a request-based Internet protocol (“N” branch), then the collaboration server application sends to the client program in step 218 the changes in the widget state, ending the process at step 220. So the flowchart in FIG. 2 depicts how the collaboration server updates or displays any changes in shared state on multiple browsers or client programs when a user's actions (clicking a button, etc.) modify the shared state of a user interface element or widget of the collaboration application running on a server on a network. For example, in an instant messaging collaboration program, when a user A clicks on a user B who is in the contact list, the click handler (event handler) creates a new collaboration group, adds both self (user A) and user B to the group, launches a chat client program through that collaboration group. The client program then starts up. When a new user is added to the group and the user's client program connects in, the shared part of the UI would be displayed with the same state that is displayed to the other users.

Turning to FIG. 3, reference numeral 300 depicts a flowchart which outlines the steps involved in creating peer widgets on collaborating client programs when a shared widget is created by the collaboration application running using the collaboration server application. In particular, when the collaboration server application launches execution of a collaboration application in step 114 of FIG. 1, the collaboration server application executes program commands as the result of the event received by the collaboration server application from a client program. As already mentioned hereinabove, the event can include the launching of a program. For each shared widget created and displayed in a widget tree in step 304, when the collaboration application is launched, the collaboration server application makes a determination in step 306, as to whether or not the shared widget has a list of existing peer widgets, that is, whether or not there are other existing peer widgets mapped to the shared widget. If it is determined in step 306 that the shared widget has a list of existing peer widgets (“Y” branch), then a new peer widget is created in the client program in step 308. In step 312, the new peer widget is initialized with the current shared state of the shared widget. However, if in step 306 it is determined that the shared widget does not have a list of existing peer widgets (“N” branch), then in step 310 a default state is set for the new peer widget created in the client program, since this is the first peer widget. After the new peer widget is initialized with the current shared state of the shared widget in step 312 and/or after a default state is set for the new peer widget in step 310, the new peer widget is added to the list of existing peer widgets mapped to the widget in step 316. In step 318, a rendering of the new peer widget is displayed on the client program, ending the process at step 320. For example, if a user, user A, starts a Java collaboration application for a chess game, a chessboard appears in the user's browsers, which contains the peer objects. There is a Java chessboard stored on the collaboration server as well with Java objects, which hold state information, that is, holds information as to where the pieces are, etc. For example, in the chess game application, if there is a black square widget in the chessboard, there will be a black square peer widget for the browser that is registered in the Java black square widget object. Now when another user, user B, connects to the same collaboration session, the collaboration server, which stores all the state information, creates another set of peers in the user B's browser. Further, the collaboration server synchronizes the new peer widgets with the state of the other peer widgets. So if a black square widget is highlighted, it will be highlighted in the peer widget created in the new user's browser or client program. The steps are the same when a shared widget tree is added to a widget tree, but one peer is added to each of the widgets in the shared widget tree. Furthermore, the steps are the same for adding widgets or widget trees into shared and unshared (non-collaborative) widget trees.

Turning to FIG. 4, reference numeral 400 depicts a flowchart which outlines the steps involved in communicating to one or more collaborating client programs changes in state of a shared widget that is modified on the collaboration server application. Referring to FIG. 1, when the event is for requesting a screen refresh in step 110, the process continues at step 402 in FIG. 4 with the collaboration server application receiving requests from the client program for a copy of the state of the shared widget. In step 404, a determination is made whether or not there are only a few changes to the widget since the client program was last updated. If there are more than only a few changes to the shared widget since the client program was last updated (“N” branch), then in step 408 the collaboration server application sends to the client program a copy of the shared widget's state, ending the process at step 410. However, if there are only a few changes to the shared widget since the client program was last updated (“Y” branch), then in step 406 the collaboration server application sends to the client program a list of all the changes to the shared widget since the last update, ending the process at step 410. As such, the customized widget libraries used by the collaboration server can automatically serialize the whole screen (frame widget) and send it to a new user joining a collaboration group. So the collaboration server communicates to a user, who joins a collaborating group at a later point-in-time, the state of the screen at that particular point-in-time. Since they are connecting to the same widget (the frame), they have access to the state information for that widget. Additionally, the collaboration server has the capability to synchronize state of the shared widget between multiple peers, since the peer widgets could be created at different times. For example, if there are four browsers that are connected to a server, the widget libraries used by the collaboration server realize that the window or frame is shared with four peers, so anytime a change occurs in the window, the widget libraries in the collaboration server handle the changes by sending a message out that notifies all the peers of the change. If one of the client programs notifies the server of a change, for instance, if peer A has made a move, the server is notified and the server notifies the other peers B, C and D. In an embodiment, one way to track changes or record changes to a shared widget is to check-point changes from the start. A check-point is a label for a sequence of changes, for instance, when a last person joined the group. When the state of a widget, (say its color) changes over the course of a period, one can record or track changes from that check-point. As such, any and all changes to a widget since the last check-point are communicated to the other peer widgets, so that those changes can be communicated to the widget which would be set to the same state as the other user(s). Alternatively, the multiple peers could be synchronized by going through an initialization sequence that transfers the state of the Java widget completely to the new peer widgets.

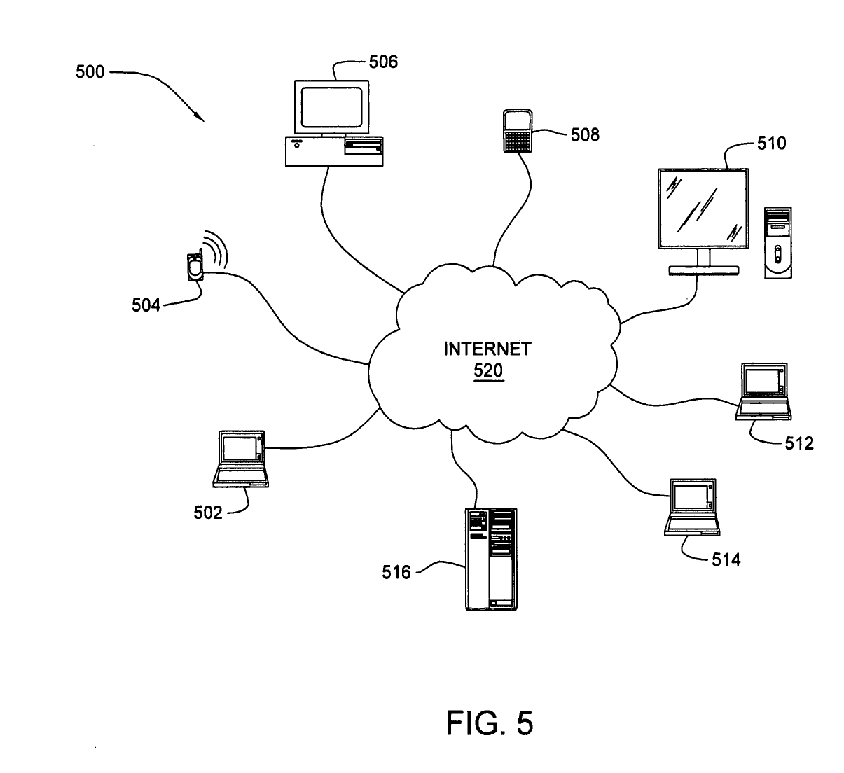

In another embodiment, the invention provides a system for facilitating collaboration in an online collaborative environment. Reference is now made to FIGS. 5-7, which depict various components of a collaboration server system having installed thereon a collaboration server application for facilitating deployment of a collaboration application on the collaboration server system. Turning to FIG. 5, reference numeral 500 depicts a collaboration system that includes a plurality of clients 502, 504, 506, 508, 510, 512 and 514 and a host server 516 connected over a network communications channel, with the host server 516 having a collaboration server application implemented thereon for facilitating deployment of a collaboration application using the collaboration server application installed on server 516 for providing collaboration among the one or more clients 502 through 514, in accordance with an embodiment of the present invention. In one embodiment, the collaboration system 500 comprises a network communications channel, for instance, the Internet 520, where a plurality of clients and servers are connected to the network communications channel 520, which serves as a communications channel for the various components of the system 500. The communications channel 520 may be, in one embodiment, an Ethernet communications channel, a wireless communications channel, or another equivalent communications channel. Further, in an embodiment, the clients include clients, such as, personal computers (506 and 510), laptops (502, 512 and 514), handheld devices, for instance, cell phones (504), personal digital assistants (PDAs 508), etc. Although, the depicted networked system 500 shown in FIG. 5 shows a single server 516 and clients 502 through 514, the system 500 may comprise a combination of various network configurations having fewer or more clients, additional servers, such as administrative servers, e-mail servers, etc. as well as alternate client-server configurations. Preferably, the clients 502-514 are configured to access the collaboration application deployed on the collaboration server 516 and to collaborate with one another over the network 520.

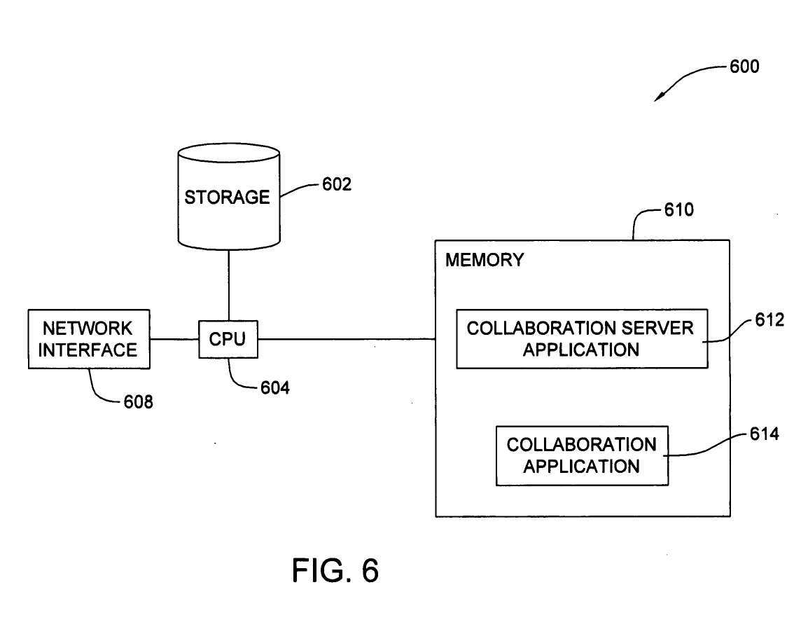

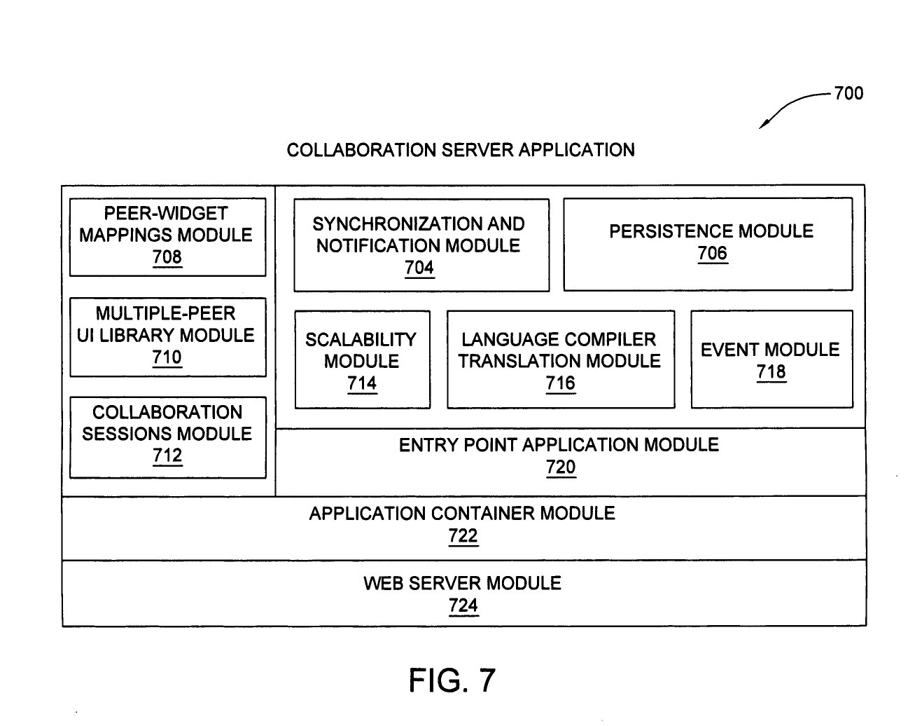

Turning to FIG. 6, FIG. 6 shows an embodiment of a collaboration server 600 having implemented thereon a collaboration server application 612 that is configured to deploy a collaboration application 614 on the server 600, in accordance with the invention. In an embodiment, the collaboration server 600 includes a central processing unit (CPU) 604, a local storage device 602, a network interface 608, and a memory 610. The CPU 604 is configured generally to execute operations within the collaboration server 600. The user interface 606, in one embodiment, is configured to allow a user to interact with the server 600, including allowing input data and commands from a user and communicating output data to the user. The network interface 608 is configured, in one embodiment, to facilitate network communications of the collaboration server 600 over a network communications channel, for instance, the Internet 502 of the network 500 (shown in FIG. 5). The local memory 610 is configured, in one embodiment, to store a collaboration server application 612 that is configured to deploy a collaboration application 614 (also stored in one embodiment in memory 610) on the server 600. The collaboration server application 612 is discussed further herein below with respect to FIG. 7. In an embodiment, the collaboration application is a web based or online collaboration application that is accessed via a web browser. However, the collaboration application does not have to be accessed using a web browser. So in an embodiment, a host server having a collaboration server application installed thereon is provided, such that when the collaboration application is dropped into the collaboration server, it lets multiple people collaborate, such as, play a game. Further, parts of the program that are shared will synchronize across the two or more client programs, so when player A moves a game piece on one screen, it will be shown on player B's screen. As such, the collaboration application running using the collaboration server application allows a screen to be displayed on the client programs of multiple users.

Turning to FIG. 7, reference numeral 700 shows an embodiment of a collaboration server application installed on a host server, such as server 600 (shown in FIG. 6), where the collaboration server application 700 facilitates deployment of a collaboration application, such as the collaboration application 614 deployed on the host server 600 of FIG. 6 having installed thereon a collaboration server application (referred to by reference numeral 612 in FIG. 6) for facilitating deployment of the collaboration application 614 on the host server 600. As shown in FIG. 7, the collaboration server application 700 installed on a host server contains a plurality of modules configured to functionally execute the necessary steps of facilitating deployment of the collaboration application deployed thereon. In particular, the collaboration server application 700 includes a web server module 724, an application container module 722, a peer-widget mappings module 708, a multiple-peer UI library module 710, a collaboration sessions module 712, a synchronization and notification module 704, a persistence module 706, a scalability module 714, a language compiler translation module 716, an event module 718, and an entry point application module 720. In an embodiment, the web server module 724 is configured to provide functionality needed to handle communications between one or more clients and the collaboration server, where the clients utilize the HTTP (Hypertext Transfer Protocol) Internet protocol for communication. Further, the application container module 722 is configured to convert the application interface of the server into a form usable by the programming language in which the collaboration application is written. For example, if the application is written in Java, the application container module is a servlet engine or a J2EE container. Moreover, the entry point application module 720 is configured to serve as the single point of entry of events from the client program, including even requests to start a collaboration application, as described with respect to FIG. 1. Further, the peer-widget mappings module 708 is configured to allow events from peer widgets to be routed to the corresponding widgets in the language of the collaboration application running on the collaboration server application. In particular, the multiple-peer UI library module 710 is configured to handle the functions of processing widget events (described with respect to FIG. 2), creating peer widgets on collaborating client programs when a shared widget is created (described with respect to FIG. 3), and communicating changes in state of a shared widget to collaborating client programs (described with respect to FIG. 4). The multiple-peer UI library module 710 uses peer-widget mappings and some knowledge regarding the collaboration sessions gathered from the collaboration sessions module 712. The collaboration sessions module 734 is configured to maintain information on the client programs that correspond to the peer widgets and allows instructions to be sent to the peer widgets by the multiple-peer UI library module. The synchronization and notification module 704 is configured to perform the task of notifying client programs that changes have taken place to shared widgets due to the actions of other client programs, so that the client programs can update their shared state information. The scalability module 714 is configured to use one of several possible strategies to take objects out of server memory and to store them in a suitable storage space until they are needed in memory again, which allows a large number of clients to simultaneously use the server without running out of memory. Further, the language compiler (Just-In-Time or JIT) translation module 716 is configured to translate parts of the collaboration application into the language used by the client programs so that these parts of the collaboration application can be executed on the clients rather than on the server, thus, improving response times and reducing network traffic and server loads. Moreover, the event module 728 is configured to convert the events sent from the client program to the collaboration server application into events of a form that the multiple-peer UI library used by the collaboration server application can understand. Further, the persistence module 706 of the collaboration server application is configured to comprise of enterprise middleware or persistence tools used by certain scalability mechanisms to store data on a database for the collaboration application.

The collaboration applications deployed in this environment can be written just like simple one-user Java programs. All the code is in one piece, a single application, rather than different programs. The programmer can write shared UI elements like chessboards by sharing the Frame or Shell where the chessboard is rendered. The programmer does not have to be aware of the network and need not write any networking or communication code. The programmer does not have to be aware of the browser and need not write any browser code. The programmer does not have to be aware of an HTTP (Hypertext Transfer Protocol) server and does not write any server code. The programmer does not have to know what part of his code runs on the server and what part of the code runs on the client. Further, the programmer can test the collaboration application code as a single user application using a framework, such as Eclipse or any other Java IDE (Integrated Development Environment). Moreover, a server API (Application Programming Interface) is used to store shared state in the collaboration server. There is no client API. In an embodiment, the collaboration server automatically initializes the state of the application of a new user to be consistent with the state of all other users already collaborating. Changes in shared state are propagated to all collaborating users automatically, for instance, using a refresh notification, such as a repaint call mechanism for communicating changes in shared state to collaborating users.

In yet another embodiment, the invention provides a computer program product for building a collaboration server application that facilitates deployment of a collaboration application upon it in the context of a host server. The computer program product comprises a computer readable or computer-usable medium, which provides program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. Preferably, the computer storage medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Further, preferably, network medium can comprise of transmission devices on a network, such as, cables, routers, switches and/or network adapter cards.

Preferably, the computer program product is in a form accessible from the computer-usable or computer-readable medium, which provides program codes or instructions for use by or in connection with a computer or any instruction execution system. For the purposes of this description, a computer-usable or computer readable medium can be any apparatus that can contain, store, communicate, propagate, or transport the codes or instructions for use by or in connection with the instruction execution system, apparatus, or device. Preferably, the medium can comprise an electronic, magnetic, optical, electromagnetic, infrared, or semiconductor system (or apparatus or device) or a propagation medium. More preferably, the computer-readable medium can comprise a semiconductor or solid state memory, magnetic tape, a removable computer diskette, a random access memory (RAM), a read-only memory (ROM), a rigid magnetic disk and an optical disk. Further, examples of optical disks include compact disc-read only memory (CD-ROM), compact disc-read/write (CD-R/W) and digital versatile/video disc (DVD). The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The computer program product comprises first program instructions to install a collaboration server application on a host server connected to a network, the collaboration server application being configured to run a collaboration application using customized widget libraries which include one or more customized widgets, each of the customized widgets being capable of creating one or more peer widgets on each local user interface of a client program corresponding to each of one or more collaborating users connected to the host server. Further, the computer program product comprises second program instructions to run on the host server a collaboration application deployed thereon, the collaboration application having a user interface written using one or more standard widget libraries and third program instructions to display a shared part of the user interface of the collaboration application on a local user interface of a client program corresponding to a new collaborating user when the new collaborating user connects to the host server. In an embodiment, the new collaborating user comprises at least one of: a first user in the collaborating group who connects to the host server at an initial point-in-time or a subsequent user in the collaborating group who connects to the host server at a subsequent point-in-time. In an embodiment, the second program instructions include instructions to key to a collaborating group the shared part of the user interface displayed as each local user interface corresponding to the one or more collaborating users. In an embodiment, the third program instructions include instructions to share between the one or more collaborating users one or more customized widgets used to render the shared part of the user interface displayed as the local user interface on the client program corresponding to the one or more collaborating users. Furthermore, the computer program product comprises fourth program instructions to update the shared part of the user interface displayed on the each local user interface corresponding to the one or more collaborating users when a change is made to the shared part of the user interface by any of the one or more collaborating users. In an embodiment, the fourth program instructions include instructions to transmit over the network the change made to the shared part of the user interface displayed as the local user interface using a protocol chosen from an Internet protocol suite. In an embodiment, each of the first, second, third and fourth program instructions are stored on the computer readable medium. In an embodiment, both the collaboration application and the collaboration server application are applications written in an object-oriented programming language, for instance, the Java programming language.

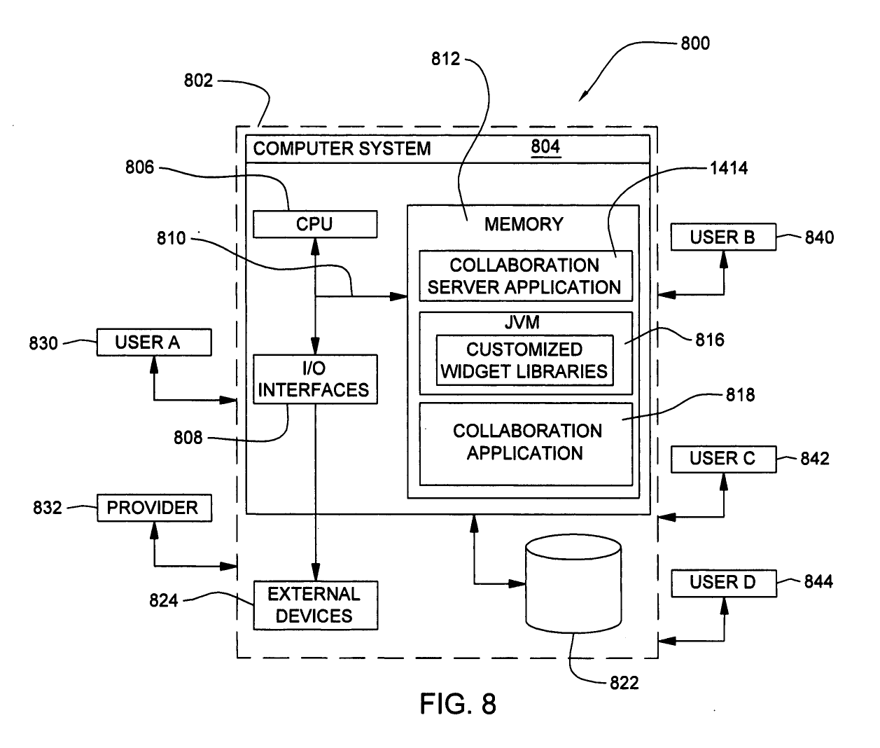

Referring now to FIG. 8, there is illustrated a system 800 for building a collaboration server application that facilitates deployment of a collaboration application, according to the present invention. As depicted, system 800 includes a computer infrastructure 802, which is intended to represent any type of computer architecture that is maintained in a secure environment (i.e., for which access control is enforced). As shown, infrastructure 802 includes a computer system 804 that typically represents a web server or the like. It should be understood, however, that although not shown, other hardware and software components (e.g., additional computer systems, such as, metric servers, administrative servers, routers, firewalls, etc.) could be included in infrastructure 802.

In general, a user A 830 interfaces with infrastructure 802 for accessing a collaboration application, for instance, a collaboration application 818 deployed on the computer system or server 804 for collaborating with other users over a network, such as the network 500 shown in FIG. 5. Similarly, one or more users B, C and D (designated by numerals 840, 842 and 844) can interface with infrastructure 802 for accessing the collaboration application 818 for collaborating with each other. For example, if the collaboration application 818 is a chess application or program, the users 830, 840, 842 and 844 can connect to the server 804 using computer infrastructure 802 for playing chess over a network with each other. To this extent, infrastructure 802 provides a secure environment. In general, the parties could access infrastructure 802 directly, or over a network via interfaces (e.g., client web browsers) loaded on computerized devices (e.g., personal computers, laptops, handheld devices, etc. shown in FIG. 5). In the case of the latter, the network can be any type of network such as the Internet (as shown in FIG. 5), or can be any other network, such as, a local area network (LAN), a wide area network (WAN), a virtual private network (VPN), etc. In any event, communication with infrastructure 802 could occur via a direct hardwired connection (e.g., serial port), or via an addressable connection that may utilize any combination of wire line and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, the parties could utilize an Internet service provider to establish connectivity to infrastructure 802. It should be understood that under the present invention, infrastructure 802 could be owned and/or operated by a party such as provider 832, or by an independent entity. Regardless, use of infrastructure 802 and the teachings described herein could be offered to the parties on a subscription or fee-basis. In either scenario, an administrator at an administrative server or any other designated computer system (not shown in FIG. 8) could support and configure infrastructure 802.

Computer system or server 804 is shown to include a CPU (hereinafter “processing unit 806”), a memory 812, a bus 810, and input/output (I/O) interfaces 808. Further, computer system 800 is shown in communication with external I/O devices/resources 824 and storage system 822. In general, processing unit 806 executes computer program codes, such as the collaboration server application 814 or program code stored in memory 812. Similarly, processing unit 806 executes the computer program code for the JVM (Java Virtual Machine) 816 having customized or multiple-peer widget libraries 816, and the collaboration application 818 that is metric collector and transmitter script inserted within each of the other web pages 816, 818 and 820. While executing the collaboration application 818 using the JVM (Java Virtual Machine) 816 having customized or multiple-peer widget libraries 816, the processing unit 806 can read and/or write data, to/from memory 812, storage system 822, and/or I/O interfaces 808. Bus 810 provides a communication link between each of the components in computer system 800. External devices 824 can comprise any devices (e.g., keyboard, pointing device, display, etc.) that enable a user to interact with computer system 800 and/or any devices (e.g., network card, modem, etc.) that enable computer system 800 to communicate with one or more other computing devices.

Computer infrastructure 802 is only illustrative of various types of computer infrastructures for implementing the invention. For example, in one embodiment, computer infrastructure 802 comprises two or more computing devices (e.g., a server cluster) that communicate over a network to perform the various process steps of the invention. Moreover, computer system 800 is only representative of various possible computer systems that can include numerous combinations of hardware. To this extent, in other embodiments, computer system 800 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 806 may comprise a single processing unit, or be distributed across one or more processing units in one or more locations, e.g., on a client and server. Similarly, memory 812 and/or storage system 822 can comprise any combination of various types of data storage and/or transmission media that reside at one or more physical locations. Further, I/O interfaces 808 can comprise any system for exchanging information with one or more external devices 824. Still further, it is understood that one or more additional components (e.g., system software, math co-processing unit, etc.) not shown in FIG. 8 can be included in computer system 800. Similarly, it is understood that the one or more external devices 824 (e.g., a display) and/or storage system(s) 822 could be contained within computer system 804, and not externally as shown.

Storage system 822 can be any type of system (e.g., a database) capable of providing storage for information under the present invention. To this extent, storage system 822 could include one or more storage devices, such as a magnetic disk drive or an optical disk drive. In another embodiment, storage system 822 includes data distributed across, for example, a local area network (LAN), wide area network (WAN) or a storage area network (SAN) (not shown). Although not shown, additional components, such as cache memory, communication systems, system software, etc., may be incorporated into computer system 800.

The foregoing descriptions of specific embodiments of the present invention have been presented for the purpose of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of building a collaboration server for facilitating deployment of a collaboration application, said method comprising the steps of:
installing a collaboration server application on a server connected to a network and being configured to run a collaboration application using one or more customized user interface libraries having collaboration functionality, each of said one or more customized user interface libraries being configured to create one or more customized widgets capable of mapping to one or more peer widgets;
deploying a collaboration application on said server, wherein a user interface of said collaboration application is written using one or more standard user interface libraries; and
launching execution of said collaboration application on said server when one or more collaborating users of a collaborating group connect to said server over said network, such that a rendering of a shared state of said user interface is displayed on a client corresponding to each of said one or more collaborating users connected to said server.

2. The method according to claim 1, further comprising the step of:
when a new collaborating user connects to said server for collaborating with said one or more collaborating users, displaying said shared state of said user interface on another client program corresponding to said new collaborating user.

3. The method according to claim 2, further comprising the step of:
when a change is made to said shared state of said user interface by a collaborating user among said one or more collaborating users, broadcasting said change made to said shared state to a remainder of said one or more collaborating users.

4. The method according to claim 3, wherein said displaying step further comprises the steps of:
keying said shared state of said user interface to said collaboration group;
storing said shared state of said user interface on said server; and
displaying said rendering of said shared state of said user interface on said another client program corresponding to said new collaborating user upon launching of said collaboration application when said new collaborating user connects to said server.

5. The method according to claim 4, wherein said broadcasting step further comprises the step of:
issuing a notification to each client program corresponding to said remainder of said one or more collaborating users, such that said rendering of said shared state of said user interface is updated to reflect said change made to said shared state of said user interface.

6. The method according to claim 5, wherein said new collaborating user comprises at least one of: a first user in said collaborating group who connects to said server at an initial point-in-time and a subsequent user in said collaborating group who connects to said server at a subsequent point-in-time.

7. The method according to claim 6, wherein said change made to said shared state of said user interface is broadcasted across said network using a protocol chosen from an Internet protocol suite.

8. The method according to claim 7, wherein said collaboration application comprises an application written in an object-oriented programming language; and wherein said collaboration server application comprises an application written in an object-oriented programming language.

9. A system for facilitating collaboration in an online collaborative environment, comprising:
a collaboration server application installed on a server coupled to a network and being configured to run a collaboration application using one or more modified widget libraries comprising of one or more customized widgets, each customized widget of said one or more customized widgets being configured to map to one or more peer widgets created on one or more local user interfaces corresponding to one or more collaborating users connected to said server; and
a collaboration application deployed on said server, said collaboration server application being configured to run said collaboration application on said server when a collaborating user connects to said server, such that a shared part of a user interface of said collaboration application run on said server is stored on said server in order to display said shared part of said user interface on each local user interface corresponding to each of said collaborating users connected to said server and wherein any change made to said shared part of said user interface displayed on a local user interface of a collaborating user among said collaborating users is broadcasted and displayed on each remaining local user interface corresponding to each remaining collaborating user among said collaborating users connected to said server.

10. The system according to claim 9, wherein said collaboration server application is configured to key said shared part of said user interface to a collaboration group comprising of said collaborating users.

11. The system according to claim 10, wherein said collaboration server application is further configured to display said shared part of said user interface on a local user interface of a new collaborating user when said new collaborating user connects to said server; and wherein said new collaborating user comprises at least one of: a first user in said collaborating group who connects to said server at an initial point-in-time and a subsequent user in said collaborating group who connects to said server at a subsequent point-in-time.

12. The system according to claim 11, wherein said collaboration server application is further configured to issue a notification to said each local user interface corresponding to said each remaining collaborating users of said collaborating users connected to said server in order to update and display said any change made to said shared part of said user interface.

13. The system according to claim 12, wherein said collaboration application comprises an application written in an object-oriented programming language; and
wherein said collaboration server application comprises an application written in an object-oriented programming language.

14. The method according to claim 13, wherein said change made to said shared state of said user interface is broadcasted across said network using a protocol chosen from an Internet protocol suite.

15. A computer program product for building a collaboration server application that facilitates deployment of a collaboration application, said computer program product comprising:
a computer readable medium;
first program instructions to install a collaboration server application on a host server connected to a network, said collaboration server application being configured to run a collaboration application using customized widget libraries comprising of one or more customized widgets, each of said customized widgets being capable of creating one or more peer widgets on each local user interface of a client program corresponding to each of one or more collaborating users connected to said host server;
second program instructions to run on said host server a collaboration application deployed thereon, said collaboration application having a user interface written using one or more standard widget libraries;
third program instructions to display a shared part of said user interface of said collaboration application on a local user interface of a client program corresponding to a new collaborating user when said new collaborating user connects to said host server;
fourth program instructions to update said shared part of said user interface displayed on said each local user interface corresponding to said one or more collaborating users when a change is made to said shared part of said user interface by any of said one or more collaborating users; and wherein said first, second, third and fourth program instructions are stored on said computer readable medium.

16. The computer program product according to claim 15, wherein said second program instructions include instructions to key to a collaborating group said shared part of said user interface displayed as said each local user interface corresponding to said one or more collaborating users.

17. The computer program product according to claim 16, wherein said third program instructions include instructions to share between said one or more collaborating users one or more customized widgets used to render said shared part of said user interface displayed as said local user interface on said client program corresponding to said one or more collaborating users.

18. The computer program product according to claim 17, wherein said new collaborating user comprises at least one of: a first user in said collaborating group who connects to said host server at an initial point-in-time and a subsequent user in said collaborating group who connects to said host server at a subsequent point-in-time.

19. The computer program product according to claim 18, wherein said fourth program instructions include instructions to transmit over said network said change made to said shared part of said user interface displayed as said local user interface using a protocol chosen from an Internet protocol suite.

20. The computer program product according to claim 19, wherein said collaboration application comprises an application written in an object-oriented programming language; and wherein said collaboration server application comprises an application written in an object-oriented programming language.
